(19) United States
(12) Patent Application Publication
(10) Pub. No.: US 2026/0280425 A1
(43) Pub. Date: Sep. 17, 2026

(54) VOLTAGE REGULATION CIRCUIT, METHOD, AND APPARATUS, AND SERVER POWER SUPPLY

(71) Applicant: SUZHOU METABRAIN INTELLIGENT TECHNOLOGY CO., LTD., Suzhou, Jiangsu (CN)

(72) Inventors: Liyu WANG, Suzhou, Jiangsu (CN); Fangzheng LI, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/878,760

(22) PCT Filed: Nov. 20, 2023
(86) PCT No.: PCT/CN2023/132742

§ 371 Date: Dec. 24, 2024

(30) Foreign Application Priority Data
Feb. 21, 2023 (CN) 202310145221.7

(51) Int. Cl. H02M 3/158; G06F 1/26; H02M 1/44; H02M 3/335

(52) U.S. Cl. CPC H02M 3/158; G06F 1/26; H02M 1/44; H02M 3/33576

(57) ABSTRACT

A voltage regulation circuit, method, and apparatus, and a server power supply. The voltage regulation circuit includes an input-output branch and a regulation branch. The regulation branch includes a signal processor, a rectification circuit, and a voltage regulator. The input-output branch outputs a direct-current voltage by controlling a switching frequency, and the regulation branch controls the direct-current voltage to be constant by regulating a target input voltage of the input-output branch. The rectification circuit is connected to the voltage regulator. An output voltage of the voltage regulator is a regulated voltage outputted by the regulation branch. The regulated voltage and a previous-stage input voltage of the voltage regulation circuit are used as the target input voltage. The signal processor is connected to the rectification circuit, and the signal processor is configured to output a first switching signal to the rectification circuit to control the regulated voltage.

### CROSS-REFERENCE TO RELATED APPLICATION

This present disclosure is a National Stage Filing of the PCT International Present disclosure No. PCT/CN2023/132742 filed on Nov. 20, 2023, which claims the priority of the Chinese Patent Application No. 202310145221.7, entitled “VOLTAGE REGULATION CIRCUIT, METHOD, AND APPARATUS, AND SERVER POWER SUPPLY” filed before the China National Intellectual Property Administration (CNIPA) on Feb. 21, 2023, which is incorporated herein by reference in its entirety.

### TECHNICAL FIELD

Embodiments of the present disclosure relate to the field of power supply components, and in particular, to a voltage regulation circuit, method, and apparatus, and a server power supply.

### BACKGROUND

With the rapid growth of Internet users, the demand for electricity in data centers also grow. This has become one of important components of energy consumption. At present, a server power supply is an indispensable part of the power supply architecture in data centers. Meanwhile, the server power supplies have increasingly high power requirements. The demand for the power of the server power supply increases on the market, but the overall space size does not increase. Moreover, with an increasing requirement for overall performance of a server, there is a desire to use a smaller space to output higher power, namely, there is a higher demand for a power density.

Different devices, different scenarios, and the like often have requirements for desired voltages. Generally, a voltage regulation circuit is required to regulate a voltage to obtain a desired voltage before connection to a corresponding load. In an existing circuit design of a voltage regulation circuit, regulation and control of a voltage are achieved by controlling switch transistors in some circuits with regulation functions. Meanwhile, other components such as an inductor and a capacitor need to be introduced into the circuits to cooperate with the switch transistors. A great increase in a switching frequency may reduce a volume of a passive component. Compared with a traditional power supply solution, the volume may be reduced, and the power density is increased. However, due to the adding of the components such as a switch transistor, a capacitor, and an inductor, the volume and complexity of a circuit may be greatly increased.

There is no effective solution proposed to solve the problem that the voltage regulation circuit in the related technology has high complexity.

### SUMMARY

The embodiments of the present disclosure provide a voltage regulation circuit, method, and apparatus, and a server power supply, to at least solve the problem that the voltage regulation circuit in the related technology has high complexity.

According to an embodiment of the present disclosure, a voltage regulation circuit is provided, including: an input-output branch and a regulation branch, wherein the regulation branch includes: a signal processor, a rectification circuit, and a voltage regulator, wherein

the input-output branch outputs a direct-current voltage by controlling a switching frequency, and the regulation branch controls the direct-current voltage to be constant by adjusting a target input voltage of the input-output branch;

the rectification circuit is connected to the voltage regulator, an output voltage of the voltage regulator is a regulated voltage output by the regulation branch, and the regulated voltage and a previous-stage input voltage of the voltage regulation circuit are used as a target input voltage; and

the signal processor is connected to the rectification circuit, and the signal processor is configured to output a first switching signal to the rectification circuit to control the regulated voltage.

Optionally, the voltage regulator includes an energy storage inductor and an output filtering capacitor, wherein

a high-level output end of the rectification circuit is connected to one end of the energy storage inductor; the other end of the energy storage inductor is connected to one end of the output filtering capacitor; the other end of the output filtering capacitor is connected to a low-level output end of the rectification circuit; and a voltage across two ends of the output filtering capacitor is the output voltage of the voltage regulator.

Optionally, the rectification circuit is a controllable rectification circuit; and the controllable rectification circuit includes one or more controllable elements, wherein

when the controllable rectification circuit includes a plurality of controllable elements, the signal processor is configured to output the first switching signal to all or part of the plurality of controllable elements.

Optionally, the one or more controllable elements form a bridge rectification circuit, wherein

one output end of the bridge rectification circuit as the high-level output end of the rectification circuit and is connected to the energy storage inductor, and the other output end of the bridge rectification circuit as the low-level output end of the rectification circuit and is connected to the output filtering capacitor.

Optionally, the one or more controllable elements include a first controllable switch transistor, a second controllable switch transistor, a third controllable switch transistor, and a fourth controllable switch transistor, which together form a full-bridge rectification circuit; and

the signal processor is respectively connected to a control end of the first controllable switch transistor, a control end of the second controllable switch transistor, a control end of the third controllable switch transistor, and a control end of the fourth controllable switch transistor.

Optionally, the signal processor is connected between an output end of the input-output branch and the rectification circuit; and

the signal processor is configured to generate a control signal according to the previous-stage input voltage and a desired output voltage of the input-output branch; wherein the control signal is used for controlling the direct-current voltage to be constant; he signal processor is configured to convert a second switching signal of the rectification circuit into the first switching signal by using the control signal; wherein the second switching signal is used for rectifying an input voltage of the regulation branch.

Optionally, the signal processor is configured to calculate a branch output voltage that is matched with the previous-stage input voltage and the desired output voltage; the signal processor is configured to determine a duty cycle that is matched with the branch output voltage; the signal processor is configured to generate the control signal that conforms to the duty cycle; and the signal processor is configured to perform an AND logical operation on the control signal and the second switching signal to obtain the first switching signal.

Optionally, the input-output branch is an LLC circuit topology, and the regulation branch is a BUCK circuit topology;

the LLC circuit topology includes a primary-side primary winding circuit and a secondary-side secondary winding circuit; the LLC circuit topology operates in a direct-current mode of MHz and transfers electric energy from the primary-side primary winding circuit to the secondary-side secondary winding circuit to output the direct-current voltage;

the BUCK circuit topology includes an energy storage inductor and an output filtering capacitor; and the rectification circuit is connected between a primary-side auxiliary winding and the BUCK circuit topology.

Optionally, the signal processor is configured to perform an AND logical operation on a switching signal of the rectification circuit and a switching signal of the BUCK circuit topology to obtain the first switching signal and input the first switching signal to the rectification circuit;

wherein the switching signal of the rectification circuit is used for controlling a rectification function of the rectification circuit; and the switching signal of the BUCK circuit topology is used for controlling a step-down function of the BUCK circuit topology.

According to another embodiment of the present disclosure, a server power supply is further provided, including: a power supply circuit and a voltage regulation circuit, wherein the voltage regulation circuit is connected between the power supply circuit and a server load to be powered;

the voltage regulation circuit includes an input-output branch and a regulation branch, wherein the regulation branch includes a signal processor, a rectification circuit, and a voltage regulator; the input-output branch outputs a direct-current voltage to the server load by controlling a switching frequency; the regulation branch controls the direct-current voltage to be constant by adjusting a target input voltage of the input-output branch;

the rectification circuit is connected to the voltage regulator; an output voltage of the voltage regulator is a regulated voltage output by the regulation branch; the regulated voltage and an output voltage of the power supply circuit are used as the target input voltage;

the signal processor is connected to the rectification circuit; and the signal processor is configured to output a first switching signal to the rectification circuit to control the regulated voltage.

Optionally, the voltage regulator includes an energy storage inductor and an output filtering capacitor; the rectification circuit is a controllable rectification circuit; one or more controllable elements included in the controllable rectification circuit form a bridge rectification circuit;

a high-level output end of the bridge rectification circuit is connected to one end of the energy storage inductor; the other end of the energy storage inductor is connected to one end of the output filtering capacitor; the other end of the output filtering capacitor is connected to a low-level output end of the bridge rectification circuit; a voltage across two ends of the output filtering capacitor is the output voltage of the voltage regulator;

the one or more controllable elements include a first controllable switch transistor, a second controllable switch transistor, a third controllable switch transistor, and a fourth controllable switch transistor, which together form a full-bridge rectification circuit; and

the signal processor is respectively connected to control ends of the one or more controllable elements.

Optionally, the signal processor is connected between an output end of the voltage regulation circuit and the rectification circuit;

the signal processor is configured to generate a control signal according to an output voltage of the power supply circuit and an operating voltage of the server load, wherein the control signal is used for controlling the direct-current voltage to be constant; the signal processor is configured to convert a second switching signal of the rectification circuit into the first switching signal by using the control signal; and the signal processor is configured to input the first switching signal to the rectification circuit, wherein the second switching signal is used for rectifying an input voltage of the regulation branch.

Optionally, the signal processor is configured to calculate a branch output voltage that is matched with the output voltage of the power supply circuit and the operating voltage of the server load; the signal processor is configured to determine a duty cycle that is matched with the branch output voltage; the signal processor is configured to generate the control signal that conforms to the duty cycle; and the signal processor is configured to perform an AND logical operation on the control signal and the second switching signal to obtain the first switching signal.

Optionally, the input-output branch is a logical link control (LLC) circuit topology, and the regulation branch is a BUCK circuit topology;

the LLC circuit topology includes a primary-side primary winding circuit and a secondary-side secondary winding circuit; the LLC circuit topology operates in a direct-current mode of MHz to transfer electric energy from the primary-side primary winding circuit to the secondary-side secondary winding circuit, to output a constant direct-current voltage to the server load;

the BUCK circuit topology includes an energy storage inductor and an output filtering capacitor; and the rectification circuit is connected between a primary-side auxiliary winding and the BUCK circuit topology.

Optionally, the signal processor is configured to perform an AND logical operation on a switching signal of the rectification circuit and a switching signal of the BUCK circuit topology to obtain the first switching signal and input the first switching signal to the rectification circuit;

wherein the switching signal of the rectification circuit is used for controlling a rectification function of the rectification circuit; and the switching signal of the BUCK circuit topology is used for controlling a step-down function of the BUCK circuit topology.

According to another embodiment of the present disclosure, a voltage regulation method is further provided, including:

generating a first switching signal according to a previous-stage input voltage of a voltage regulation circuit and a second switching signal of a rectification circuit in the voltage regulation circuit, wherein the voltage regulation circuit includes: an input-output branch and a regulation branch; the regulation branch includes: the rectification circuit and a voltage regulator; the input-output branch outputs a direct-current voltage by controlling a switching frequency, and the regulation branch controls the direct-current voltage to be constant by adjusting a target input voltage of the input-output branch; the rectification circuit is connected to the voltage regulator; an output voltage of the voltage regulator is a regulated voltage; the regulated voltage and the previous-stage input voltage are used as the target input voltage; the second switching signal is used for rectifying an input voltage of the regulation branch; and

outputting the first switching signal to the rectification circuit, wherein the first switching signal is used for controlling the regulated voltage.

Optionally, generating the first switching signal according to the previous-stage input voltage of the voltage regulation circuit and the second switching signal of the rectification circuit in the voltage regulation circuit includes:

generating a control signal according to the previous-stage input voltage and a desired output voltage of the input-output branch, wherein the control signal is used for controlling the direct-current voltage to be constant; and

using the control signal to convert the second switching signal of the rectification circuit into the first switching signal.

Optionally, generating the control signal according to the previous-stage input voltage and the desired output voltage of the input-output branch includes:

calculating a branch output voltage that is matched with the previous-stage input voltage and the desired output voltage;

determining a duty cycle that is matched with the branch output voltage; and

generating the control signal that conforms to the duty cycle.

Optionally, using the control signal to convert the second switching signal of the rectification circuit into the first switching signal includes:

performing an AND logical operation on the control signal and the second switching signal to obtain the first switching signal.

According to still another embodiment of the present disclosure, a voltage regulation apparatus is further provided, including:

a generation module, configured to: generate a first switching signal according to a previous-stage input voltage of a voltage regulation circuit and a second switching signal of a rectification circuit in the voltage regulation circuit, wherein the voltage regulation circuit includes: an input-output branch and a regulation branch; the regulation branch includes: the rectification circuit and a voltage regulator; the input-output branch outputs a direct-current voltage by controlling a switching frequency, and the regulation branch controls the direct-current voltage to be constant by adjusting a target input voltage of the input-output branch; the rectification circuit is connected to the voltage regulator; an output voltage of the voltage regulator is a regulated voltage; the regulated voltage and the previous-stage input voltage are used as the target input voltage; the second switching signal is used for rectifying an input voltage of the regulation branch; and

an output module, configured to output the first switching signal to the rectification circuit, wherein the first switching signal is used for controlling the regulated voltage.

According to yet another embodiment of the present disclosure, a non-volatile readable storage medium is further provided. The non-volatile readable storage medium has a computer program stored thereon, and the computer program is used for, when run, executing the operations in any one of the above method embodiments.

According to yet still another embodiment of the present disclosure, an electronic device is further provided, including a memory and a processor. The memory has a computer program stored thereon. The processor is configured for running the computer program to execute the operations in any one of the above method embodiments.

Through the present disclosure, the voltage regulation circuit includes: an input-output branch and a regulation branch. The input-output branch outputs a direct-current voltage by controlling a switching frequency. The regulation branch controls the direct-current voltage to be constant by adjusting a target input voltage of the input-output branch. The regulation branch includes: a signal processor, a rectification circuit, and a voltage regulator. The rectification circuit is connected to the voltage regulator. An output voltage of the voltage regulator is a regulated voltage output by the regulation branch. The regulated voltage and the previous-stage input voltage of the voltage regulation circuit are used as the target input voltage. The signal processor is connected to the rectification circuit. The signal processor is configured to output a first switching signal to the rectification circuit to control the regulated voltage. Namely, the voltage regulation is controlled by the first switching signal provided to the rectification circuit, instead of controlling the voltage regulator, so that an additional switch transistor, inductor, capacitor, diode, and the like do not need to be added into the voltage regulation circuit. Due to the deployment of eliminating a plurality of devices in the voltage regulation circuit, a space occupied by a device is saved. Therefore, the problem of high complexity of the voltage regulation circuit is solved, and thus, an effect of reducing the complexity of the voltage regulation circuit is achieved.

### BRIEF DESCRIPTION OF THE DRAWINGS

FIG. 1 is a schematic diagram I of an optional voltage regulation circuit according to an embodiment of the present disclosure;

FIG. 2 is a schematic diagram Il of an optional voltage regulation circuit according to an embodiment of the present disclosure;

FIG. 3 is a schematic diagram of a Regulated DC Transformer (RDCX) auxiliary winding branch according to an optional implementation of the present disclosure;

FIG. 4 is a schematic diagram of an RDCX circuit according to an optional implementation of the present disclosure;

FIG. 5 is a schematic diagram of an optional server power supply according to an embodiment of the present disclosure;

FIG. 6 is a structural block diagram of hardware of a mobile terminal in a voltage regulation method according to an embodiment of the present disclosure;

FIG. 7 is a flowchart of a voltage regulation method according to an embodiment of the present disclosure; and

FIG. 8 is a structural block diagram of a voltage regulation apparatus according to an embodiment of the present disclosure.

### DETAILED DESCRIPTION OF THE EMBODIMENTS

The embodiments of the present disclosure will be described in detail below with reference to the accompanying drawings and the embodiments.

It should be noted that the terms “first”, “second”, etc. in the specification and claims of the present disclosure and the above accompanying drawings are defined to distinguish similar objects, and do not have to be used to describe a specific order or sequence.

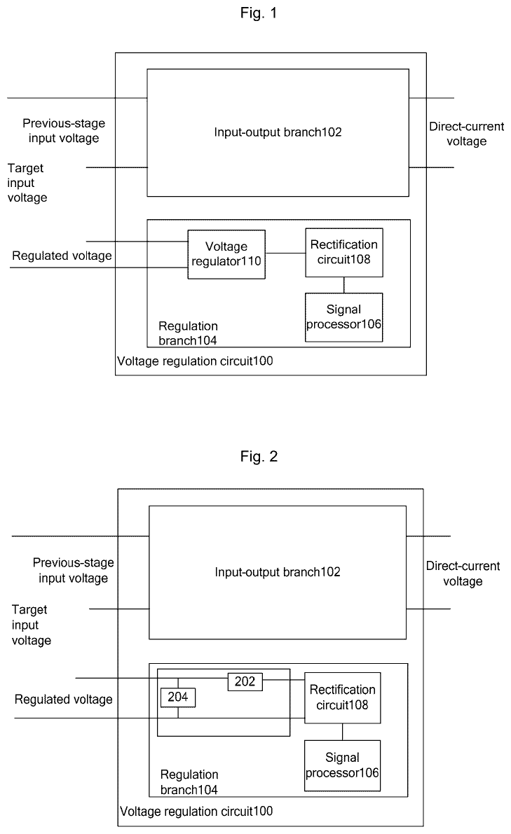

This embodiment provides a voltage regulation circuit. FIG. 1 is a schematic diagram I of an optional voltage regulation circuit according to an embodiment of the present disclosure. As shown in FIG. 1, the voltage regulation circuit 100 includes: an input-output branch 102 and a regulation branch 104. The regulation branch 104 includes: a signal processor 106, a rectification circuit 108, and a voltage regulator 110.

The input-output branch 102 outputs a direct-current voltage by controlling a switching frequency. The regulation branch 104 controls the direct-current voltage to be constant by adjusting a target input voltage of the input-output branch 102.

The rectification circuit 108 is connected to the voltage regulator 110. An output voltage of the voltage regulator 110 is a regulated voltage output by the regulation branch. The regulated voltage and a previous-stage input voltage of the voltage regulation circuit 100 are used as the target input voltage.

The signal processor 106 is connected to the rectification circuit 108. The signal processor 106 is configured to output a first switching signal to the rectification circuit 108 to control the regulated voltage.

Through the above device, the voltage regulation circuit includes: an input-output branch and a regulation branch. The input-output branch outputs a direct-current voltage by controlling a switching frequency. The regulation branch controls the direct-current voltage to be constant by adjusting a target input voltage of the input-output branch. The regulation branch includes: a signal processor, a rectification circuit, and a voltage regulator. The rectification circuit is connected to the voltage regulator. An output voltage of the voltage regulator is a regulated voltage output by the regulation branch. The regulated voltage and the previous-stage input voltage of the voltage regulation circuit are used as the target input voltage. The signal processor is connected to the rectification circuit. The signal processor is configured to output a first switching signal to the rectification circuit to control the regulated voltage. Namely, the voltage regulation is controlled by the first switching signal provided to the rectification circuit, instead of controlling the voltage regulator, so that an additional switch transistor, inductor, capacitor, diode, and the like do not need to be added into the voltage regulation circuit. Due to the deployment of eliminating a plurality of components in the voltage regulation circuit, a space occupied by the device is saved. Therefore, the problem of high complexity of the voltage regulation circuit is solved, and thus, an effect of reducing the complexity of the voltage regulation circuit is achieved.

Optionally, in this embodiment, the above voltage regulation circuit may be, but is not limited to, a Regulated DC Transformer (RDCX). The RDCX combines a Logical Link Control (LLC) circuit topology with a BUCK (a step-down conversion circuit) circuit topology, so that the LLC operates in a DC transformer (DCX) mode of MHz. Closed-loop control of the regulated DC transformer is completed by controlling a BUCK circuit that operates at a relatively low frequency (e.g. 200 KHz). For example, the input-output branch is an LLC circuit topology, and the regulation branch is a BUCK circuit topology. The LLC circuit topology includes a primary-side primary winding circuit and a secondary-side secondary winding circuit. The LLC circuit topology operates in a direct-current mode of Mega Hertz (MHz) and transfers electric energy from the primary-side primary winding circuit to the secondary-side secondary winding circuit to output the direct-current voltage. The BUCK circuit topology includes an energy storage inductor and an output filtering capacitor. The rectification circuit is connected between a primary-side auxiliary winding and the BUCK circuit topology.

Optionally, in this embodiment, the signal processor is configured to perform an AND logical operation on a switching signal of the rectification circuit and a switching signal of the BUCK circuit topology to obtain the first switching signal and input the first switching signal to the rectification circuit. The switching signal of the rectification circuit is used for controlling a rectification function of the rectification circuit; and the switching signal of the BUCK circuit topology is used for controlling a step-down function of the BUCK circuit topology.

Optionally, in this embodiment, the signal processor is configured to control the output voltage of the regulation branch by controlling the switching signal of the rectification circuit, which may eliminate the need for a switch transistor and a freewheeling diode in the voltage regulator and save a circuit space.

Optionally, in this embodiment, the regulation branch can, but is not limited to, use a form of a step-down circuit, a boost circuit, a boost and step-down circuit, or the like. The step-down circuit may be, but is not limited to, in a form of a BUCK circuit. However, the switching signal for regulating a voltage is implemented through the switching signal of the rectification circuit, so that there is no need to add a switch transistor and an inductor, a capacitor, or the like cooperating with the switch transistor into the BUCK circuit, thereby reducing the complexity of the circuit and saving a deployment space.

In an exemplary embodiment, FIG. 2 is a schematic diagram II of an optional voltage regulation circuit according to an embodiment of the present disclosure. As shown in FIG. 2, the voltage regulator 110 includes an energy storage inductor 202 and an output filtering capacitor 204. A high-level output end of the rectification circuit 108 is connected to one end of the energy storage inductor 202, and the other end of the energy storage inductor 202 is connected to one end of the output filtering capacitor 204. The other end of the output filtering capacitor 204 is connected to a low-level output end of the rectification circuit 108. A voltage across two ends of the output filtering capacitor 204 is the output voltage of the voltage regulator 110.

Optionally, in this embodiment, the voltage regulator may include, but is not limited to, a capacitor or an inductor, or a combination of a capacitor and an inductor, which is used for outputting a voltage of the regulation branch.

Optionally, in this embodiment, the above output filtering capacitor may play a role of, but is not limited to, outputting a voltage, and the above energy storage inductor may play a role of, but is not limited to, storing energy. The BUCK circuit is taken as an example. The output filtering capacitor may be, but is not limited to, Cbuck, and the energy storage inductor may be, but is not limited to, Lbuck.

In an exemplary embodiment, the rectification circuit is a controllable rectification circuit. The controllable rectification circuit includes: one or more controllable elements. When the controllable rectification circuit includes a plurality of controllable elements, the signal processor is configured to output the first switching signal to all or part of the plurality of controllable elements.

Optionally, in this embodiment, the rectification circuit may use, but is not limited to, various forms of rectification circuits with controllable functions, including: one or more controllable elements. When the controllable rectification circuit includes a plurality of controllable elements, the first switching signal for regulating the output voltage of the regulation branch while rectifying the input signal of the rectification circuit includes switching signals of all or part of the plurality of controllable elements.

In an exemplary embodiment, the one or more controllable elements form a bridge rectification circuit. One output end of the bridge rectification circuit as the high-level output end of the rectification circuit and is connected to the energy storage inductor, and the other output end of the bridge rectification circuit as the low-level output end of the rectification circuit and is connected to the output filtering capacitor.

Optionally, in this embodiment, the rectification circuit may be implemented using, but is not limited to, a bridge rectification circuit. One output end of the bridge rectification circuit is used as the high-level output end of the rectification circuit and directly connected to the energy storage inductor, and the other output end of the bridge rectification circuit is used as the low-level output end of the rectification circuit and directly connected to the output filtering capacitor, thereby eliminating a voltage stabilizer in the rectification circuit, such as a voltage stabilizing capacitor C1, which further saves a space occupied by the circuit and reduces the complexity of the voltage regulation circuit.

Optionally, in this embodiment, the controllable rectification circuit may be, but is not limited to, in a form of a full-bridge rectification circuit, or may be, but is not limited to, in a form of a half-bridge rectification circuit.

In an exemplary embodiment, the one or more controllable elements include a first controllable switch transistor, a second controllable switch transistor, a third controllable switch transistor, and a fourth controllable switch transistor, which together form a full-bridge rectification circuit; and the signal processor is respectively connected to a control end of the first controllable switch transistor, a control end of the second controllable switch transistor, a control end of the third controllable switch transistor, and a control end of the fourth controllable switch transistor.

Optionally, in this embodiment, the signal processor is connected to the control ends of all the controllable switch transistors in the full-bridge rectification circuit.

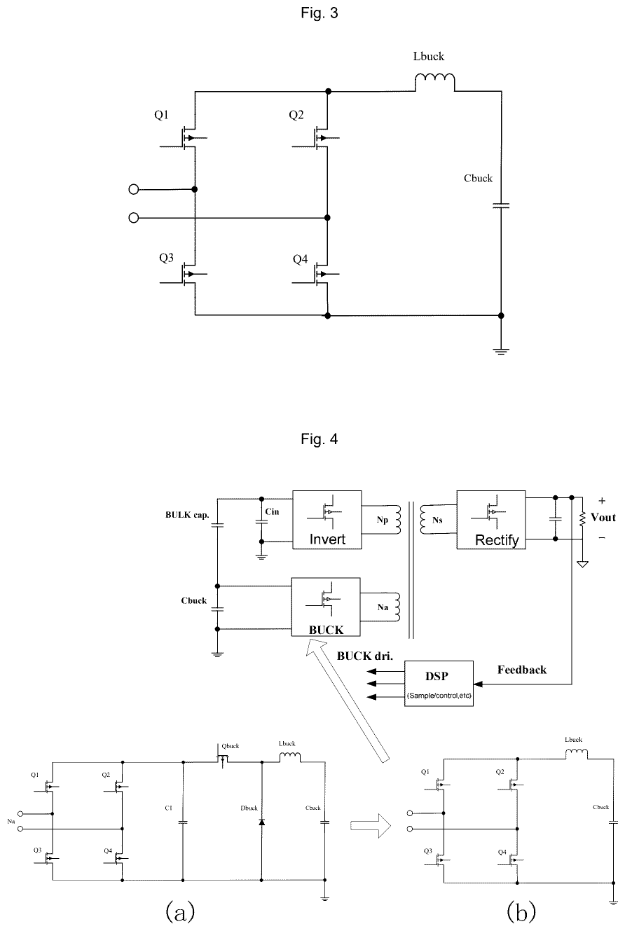

In an optional implementation, an RDCX auxiliary winding branch being the regulation branch is taken as an example. FIG. 3 is a schematic diagram of a RDCX auxiliary winding branch according to an optional implementation of the present disclosure. As shown in FIG. 3, the RDCX auxiliary winding branch eliminates three components: a capacitor C1, a switch transistor Qbuck, and a freewheeling diode Dbuck from the original BUCK circuit. Lbuck is the above energy storage inductor, and Cbuck is the above output filtering capacitor.

In the RDCX scheme, switching frequencies from Q1 to Q4 follow a main transformer at level MHz. An operating frequency of the BUCK circuit is several hundred KHz. Since the BUCK circuit controls energy transfer through turning on and turning off of the switch transistor. After “AND” logical operation is performed on switching signals from Q1 to Q4 and a switching signal of an original Qbuck, Q1 to Q4 are controlled. Q1 to Q4 may achieve the same function as the Qbuck, thus eliminating C1, switch transistor Qbuck, and diode Dbuck.

In an optional implementation, the signal processor is connected between an output end of the input-output branch and the rectification circuit. The signal processor is configured to generate a control signal according to the previous-stage input voltage and a desired output voltage of the input-output branch. The control signal is used for controlling the direct-current voltage to be constant. The signal processor is configured to convert a second switching signal of the rectification circuit into the first switching signal by using the control signal. The second switching signal is used for rectifying an input voltage of the regulation branch.

Optionally, in this embodiment, the signal processor may include but is not limited to: a Digital Signal Processor (DSP), a Central Processing Unit (CPU), a control chip, and the like.

Optionally, in this embodiment, the previous-stage input voltage of the voltage regulation circuit may be, but is not limited to, a voltage across two ends of a BULK capacitor on a primary winding branch of the RDCX. The desired output voltage is an operating voltage that the RDCX expects to output.

Optionally, in this embodiment, the signal processor is configured to first generate a control signal for controlling the output voltage of the branch to be matched with the previous-stage input voltage and the desired output voltage, and then use this control signal to convert the second switching signal of the rectification circuit, so that the first switching signal obtained after conversion may achieve a function of regulating an output voltage of the step-down circuit when achieving an original function of rectifying an input signal of an auxiliary winding.

In an exemplary embodiment, the signal processor is configured to calculate a branch output voltage that is matched with the previous-stage input voltage and the desired output voltage; the signal processor is configured to determine a duty cycle that is matched with the branch output voltage; the signal processor is configured to generate the control signal that conforms to the duty cycle; and the signal processor is configured to perform an AND logical operation on the control signal and the second switching signal to obtain the first switching signal.

Optionally, in this embodiment, the duty cycle may be, but is not limited to, a duty cycle required by the BUCK circuit to achieve desired voltage regulation, and the function of the control signal may be to control a switch transistor in an original BUCK circuit to achieve the above duty cycle.

Optionally, in this embodiment, the signal processor is configured to perform an AND logical operation on the control signal and the second switching signal, to assign the function of the control signal to the second switching signal, so that the first switching signal obtained after the operation may achieve the function of the second switching signal to rectify the input signal of the auxiliary winding and achieve the function of the control signal to regulate the output voltage of the step-down circuit.

Optionally, in this embodiment, the signal processor may also be configured to control the rectification circuit according to a feedback of a current operating voltage during the operation of the regulated DC transformer, thereby controlling the rectification circuit to rectify the input signal of the auxiliary winding and controlling the output voltage of the regulation branch to be matched with the desired output voltage, to achieving stable outputting of the voltage regulation circuit.

In the above optional implementation, the voltage regulation circuit in the form of the RDCX circuit is provided. FIG. 4 is a schematic diagram of an RDCX circuit according to an optional implementation of the present disclosure. As shown in FIG. 4, an LLC operates at a high-frequency DCX mode of MHz, namely, closed-loop control will not be performed. Closed-loop control of a system is achieved through a BUCK circuit behind a primary-side auxiliary winding Na, with a relatively low operating frequency, typically several hundred KHz. A first-stage rectification circuit exists between the BUCK circuit and the auxiliary winding Na.

A branch of the auxiliary winding Na uses the above form of the auxiliary winding branch, which uses the form shown in (b), instead of the original form shown in (a). In (a), Na represents an auxiliary winding of a transformer. After being rectified by a rectification circuit composed of Q1 to Q4 and C1, Na serves as an input of the BUCK circuit. By controlling a switch transistor Qbuck of the BUCK circuit, an output voltage of the BUCK circuit may be regulated, namely, a voltage across two ends a capacitor Cbuck may be regulated, thereby regulating an input voltage of an RDCX to control the entire circuit. In (b), switching frequencies of Q1 to Q4 follows a switching frequency of a main transformer at MHz. An operating frequency of the BUCK circuit is several hundred KHz. Since the BUCK circuit controls energy transfer through turning on and turning off of the switch transistor. After “AND” logical operation is performed on switching signals from Q1 to Q4 and a switching signal of an original Qbuck, Q1 to Q4 are controlled. Q1 to Q4 may achieve the same function as Qbuck, thus eliminating C1, switch transistor Qbuck, and diode Dbuck.

The working process of the above circuit is as follows: A switching frequency of LLC-DCX is set to 1 MHz; a duty cycle is set to 0.5 (i.e. switching signals of primary, secondary, and auxiliary windings of the transformer all have the duty cycles of 0.5); a turn ratio Np:Ns:Na of the transformer is 8:1:2; and a voltage across two ends of a BULK capacitor is a previous-stage input voltage, ranging from 380 V to 420 V. When an output voltage of a main path is 54 V, a corresponding input voltage on the primary side of LLC-DCX is 432 V. In (a), a voltage across two ends of C1 after rectification of the auxiliary winding of the transformer is 108 V. In (b), a rectified output voltage is about 120 V after capacitor C1 is removed (in this case, no “AND” logic is performed on the switching signal of Qbuck). When a current PFC output voltage (i.e. the voltage at the two ends of the BULK capacitor) is 400 V, the BUCK voltage needs to be regulated to 32 V to ensure a normal output of 54 V. In this case, the duty cycle of the BUCK circuit needs to be regulated to 0.27, and then “AND” logic is performed on the switching signals of the full-bridge rectification switch transistors Q1 to Q4 to control the duty cycles of Q1 to Q4 to 0.27, thereby controlling an output voltage of 32 V of the “BUCK” branch and achieving an output of 54 V output from the main path.

When the PFC output voltage suddenly decreases, such as, to 380 V, in theory, the output voltage may decrease. In this case, when a feedback signal output by the main path is detected to decrease, the duty cycle of the BUCK circuit duty cycle will be regulated to be increased. Similarly, the “AND” logic is performed to control the switch transistors Q1 to Q4 to work to regulate the output voltage of the auxiliary branch to 52 V, thereby ensuring a steady-state output of 54 V.

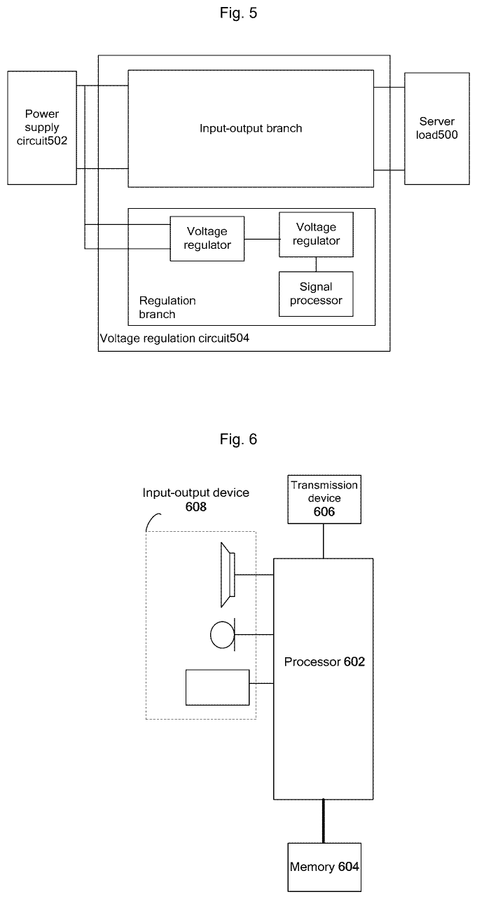

This embodiment further provides a server power supply. FIG. 5 is a schematic diagram of an optional server power supply according to an embodiment of the present disclosure. As shown in FIG. 5, the server power supply includes:

a power supply circuit 502 and a voltage regulation circuit 504. The voltage regulation circuit 504 is connected between the power supply circuit 502 and a server load 500 to be powered.

The voltage regulation circuit 504 includes an input-output branch and a regulation branch. The regulation branch includes a signal processor, a rectification circuit, and a voltage regulator; the input-output branch outputs a direct-current voltage to the server load 500 by controlling a switching frequency; the regulation branch controls the direct-current voltage to be constant by adjusting a target input voltage of the input-output branch;

the rectification circuit is connected to the voltage regulator; an output voltage of the voltage regulator is a regulated voltage output by the regulation branch; the regulated voltage and an output voltage of the power supply circuit are used as the target input voltage;

the signal processor is connected to the rectification circuit; and the signal processor is configured to output a first switching signal to the rectification circuit to control the regulated voltage.

Through the above device, the voltage regulation circuit includes: an input-output branch and a regulation branch. The input-output branch outputs a direct-current voltage by controlling a switching frequency. The regulation branch controls the direct-current voltage to be constant by adjusting a target input voltage of the input-output branch. The regulation branch includes: a signal processor, a rectification circuit, and a voltage regulator. The rectification circuit is connected to the voltage regulator. An output voltage of the voltage regulator is a regulated voltage output by the regulation branch. The regulated voltage and the previous-stage input voltage of the voltage regulation circuit are used as the target input voltage. The signal processor is connected to the rectification circuit. The signal processor is configured to output a first switching signal to the rectification circuit to control the regulated voltage. Namely, the voltage regulation is controlled by the first switching signal provided to the rectification circuit, instead of controlling the voltage regulator, so that an additional switch transistor, inductor, capacitor, diode, and the like do not need to be added into the voltage regulation circuit. Due to the deployment of eliminating a plurality of components in the voltage regulation circuit, a space occupied by the device is saved. Therefore, the problem of high complexity of the voltage regulation circuit is solved, and thus, an effect of reducing the complexity of the voltage regulation circuit is achieved.

In an exemplary embodiment, the voltage regulator includes an energy storage inductor and an output filtering capacitor; the rectification circuit is a controllable rectification circuit; one or more controllable elements included in the controllable rectification circuit form a bridge rectification circuit;

a high-level output end of the bridge rectification circuit is connected to one end of the energy storage inductor; the other end of the energy storage inductor is connected to one end of the output filtering capacitor; the other end of the output filtering capacitor is connected to a low-level output end of the bridge rectification circuit; a voltage across two ends of the output filtering capacitor is the output voltage of the voltage regulator;

the one or more controllable elements include a first controllable switch transistor, a second controllable switch transistor, a third controllable switch transistor, and a fourth controllable switch transistor, which together form a full-bridge rectification circuit; and

the signal processor is respectively connected to control ends of the one or more controllable elements.

In an exemplary embodiment, the signal processor is connected between an output end of the voltage regulation circuit and the rectification circuit;

the signal processor is configured to generate a control signal according to an output voltage of the power supply circuit and an operating voltage of the server load, wherein the control signal is used for controlling the direct-current voltage to be constant; the signal processor is configured to convert a second switching signal of the rectification circuit into the first switching signal by using the control signal, and the signal processor is configured to input the first switching signal to the rectification circuit, wherein the second switching signal is used for rectifying an input voltage of the regulation branch.

In an exemplary embodiment, the signal processor is configured to calculate a branch output voltage that is matched with the output voltage of the power supply circuit and the operating voltage of the server load; the signal processor is configured to determine a duty cycle that is matched with the branch output voltage; the signal processor is configured to generate the control signal that conforms to the duty cycle; and the signal processor is configured to perform an AND logical operation on the control signal and the second switching signal to obtain the first switching signal.

In an exemplary embodiment, the input-output branch is an LLC circuit topology, and the regulation branch is a BUCK circuit topology;

the LLC circuit topology includes a primary-side primary winding circuit and a secondary-side secondary winding circuit; the LLC circuit topology operates in a direct-current mode of MHz to transfer electric energy from the primary-side primary winding circuit to the secondary-side secondary winding circuit, to output a constant direct-current voltage to the server load;

the BUCK circuit topology includes an energy storage inductor and an output filtering capacitor; and the rectification circuit is connected between a primary-side auxiliary winding and the BUCK circuit topology.

In an exemplary embodiment, the signal processor is configured to perform an AND logical operation on a switching signal of the rectification circuit and a switching signal of the BUCK circuit topology to obtain the first switching signal and input the first switching signal to the rectification circuit;

the switching signal of the rectification circuit is used for controlling a rectification function of the rectification circuit; and the switching signal of the BUCK circuit topology is used for controlling a step-down function of the BUCK circuit topology.

The method embodiments according to the embodiments of the present disclosure may be performed on a mobile terminal, a computer terminal, or a similar computing device. Running on a mobile terminal is taken as an example. FIG. 6 is a structural block diagram of hardware of a mobile terminal in a voltage regulation method according to an embodiment of the present disclosure. As shown in FIG. 6, the mobile terminal may include one or more processors 602 (only one processor is shown in FIG. 6) (the processor 602 may include but are not limited to a micro processing unit (MCU), a field programmable gate array (FPGA), and other processing apparatuses) and a memory 604 configured to store data. The above mobile terminal may also include a transmission device 606 with a communication function and an input/output device 608 with a communication function. A person of ordinary skill in the art may understood that the structures shown in FIG. 6 are only illustrative, and a limitation will not be made on the structures of the mobile terminal. For example, the mobile terminal may also include more or fewer components than those shown in FIG. 6, or have configurations different from those shown in FIG. 6.

The memory 604 may be configured to store a computer program, such as a software program and a module of application software, such as a computer program corresponding to a control method for a regulated DC transformer in the embodiments of the present disclosure. The processor 602 executes various functional applications and data processing by running the computer program stored in the memory 604, namely, to implement the above method. The memory 604 may include high-speed random access memory and may also include a non-volatile memory, such as one or more magnetic storage apparatuses, a flash memory, or other non-volatile solid-state memories. In some instances, the memory 604 may further include a memory remotely located with respect to the processor 602. These remote memories may be connected to the mobile terminal through a network. Examples of the above network include, but are not limited to, Internets, intranets, local area networks, mobile communication networks, and combinations thereof.

The transmission device 606 is configured for receiving or transmitting data through a network. The optional examples of the above network may include a wireless network provided by a communication provider of the mobile terminal. In one example, the transmission device 606 includes a Network Interface Controller (NIC) that may be connected to other network devices through a base station for communication with the Internet. In an example, the transmission device 606 may be a Radio Frequency (RF) module configured to communicate with the Internet in a radio manner.

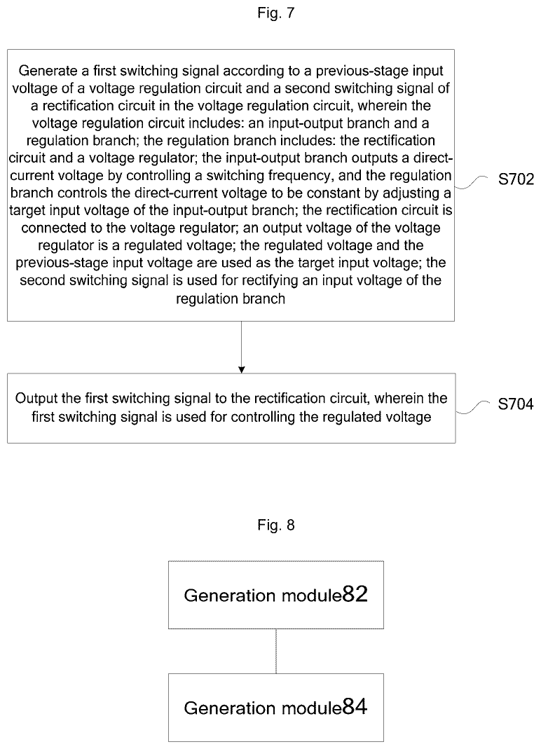

This embodiment provides a voltage regulation method. FIG. 7 is a flowchart of a voltage regulation method according to an embodiment of the present disclosure. As shown in FIG. 7, the flow includes the following operations:

S702, a first switching signal is generated according to a previous-stage input voltage of a voltage regulation circuit and a second switching signal of a rectification circuit in the voltage regulation circuit, wherein the voltage regulation circuit includes: an input-output branch and a regulation branch; the regulation branch includes: the rectification circuit and a voltage regulator; the input-output branch outputs a direct-current voltage by controlling a switching frequency, and the regulation branch controls the direct-current voltage to be constant by adjusting a target input voltage of the input-output branch; the rectification circuit is connected to the voltage regulator; an output voltage of the voltage regulator is a regulated voltage; the regulated voltage and the previous-stage input voltage are used as the target input voltage; the second switching signal is used for rectifying an input voltage of the regulation branch; and

S704, the first switching signal is output to the rectification circuit, wherein the first switching signal is used for controlling the regulated voltage.

Through the above operations, the voltage regulation circuit includes: an input-output branch and a regulation branch. The input-output branch outputs a direct-current voltage by controlling a switching frequency. The regulation branch controls the direct-current voltage to be constant by adjusting a target input voltage of the input-output branch. The regulation branch includes: a signal processor, a rectification circuit, and a voltage regulator. The rectification circuit is connected to the voltage regulator. An output voltage of the voltage regulator is a regulated voltage output by the regulation branch. The regulated voltage and the previous-stage input voltage of the voltage regulation circuit are used as the target input voltage. The signal processor is connected to the rectification circuit. The signal processor is configured to output a first switching signal to the rectification circuit to control the regulated voltage. Namely, the voltage regulation is controlled by the first switching signal provided to the rectification circuit, instead of controlling the voltage regulator, so that an additional switch transistor, inductor, capacitor, diode, and the like do not need to be added into the voltage regulation circuit. Due to the deployment of eliminating a plurality of components in the voltage regulation circuit, a space occupied by the device is saved. Therefore, the problem of high complexity of the voltage regulation circuit is solved, and thus, an effect of reducing the complexity of the voltage regulation circuit is achieved.

The above voltage regulation process may be applied to, but is not limited to, the above signal processor.

Optionally, in this embodiment, the signal processor may include but is not limited to: a Digital Signal Processing (DSP), a Central Processing Unit (CPU), a control chip, and the like.

In the technical solution provided by operation S702 above, the regulation branch can, but is not limited to, use a form of a step-down circuit, a boost circuit, a boost and step-down circuit, or the like. The step-down circuit may be, but is not limited to, in a form of a BUCK circuit. However, the switching signal for regulating a voltage is implemented through the switching signal of the rectification circuit, so that there is no need to add a switch transistor and an inductor, a capacitor, or the like cooperating with the switch transistor into the BUCK circuit, thereby reducing the complexity of the circuit and saving a deployment space.

In an exemplary embodiment, the first switching signal may be generated according to the previous-stage input voltage of the voltage regulation circuit and the second switching signal of the rectification circuit in the voltage regulation circuit in the following way, but not limited to: generating a control signal according to the previous-stage input voltage and a desired output voltage of the input-output branch, wherein the control signal is used for controlling the direct-current voltage to be constant; and using the control signal to convert the second switching signal of the rectification circuit into the first switching signal.

Optionally, in this embodiment, the previous-stage input voltage of the voltage regulation circuit may be, but is not limited to, a voltage across two ends of a BULK capacitor on a primary winding branch of the RDCX. The desired output voltage is an operating voltage that the RDCX expects to output.

Optionally, in this embodiment, a control signal for controlling the output voltage of the branch to be matched with the previous-stage input voltage and the desired output voltage is first generated, and then this control signal is used to convert the second switching signal of the rectification circuit, so that the first switching signal obtained after conversion may achieve a function of regulating an output voltage of the step-down circuit when achieving an original function of rectifying an input signal of an auxiliary winding.

In an exemplary embodiment, the control signal may be generated according to the previous-stage input voltage and the desired output voltage of the input-output branch in the following way, but not limited to: calculating a branch output voltage that is matched with the previous-stage input voltage and the desired output voltage; determining a duty cycle that is matched with the branch output voltage; and generating the control signal that conforms to the duty cycle.

Optionally, in this embodiment, the duty cycle may be, but is not limited to, a duty cycle required by the BUCK circuit to achieve desired voltage regulation, and the function of the control signal may be to control a switch transistor in an original BUCK circuit to achieve the above duty cycle.

In an exemplary embodiment, the control signal is used to convert the second switching signal of the rectification circuit into the first switching signal in the following way, but not limited to: performing an AND logical operation on the control signal and the second switching signal to obtain the first switching signal.

Optionally, in this embodiment, AND logical operation is performed on the control signal and the second switching signal, to assign the function of the control signal to the second switching signal, so that the first switching signal obtained after the operation may achieve the function of the second switching signal to rectify the input signal of the auxiliary winding and achieve the function of the control signal to regulate the output voltage of the step-down circuit.

According to the descriptions in the foregoing implementations, a person skilled in the art may clearly learn that the method according to the foregoing embodiments may be implemented by relying on software and an essential commodity hardware platform or by using hardware, but the former is a better implementation in most cases. Based on such an understanding, the technical solutions of present disclosure essentially, or the part contributing to the related technology, may be presented in the form of a software product. The computer software product is stored in a non-volatile readable storage medium (e.g. a read only memory/random access memory (ROM/RAM), a magnetic disk, or a compact disc) including several instructions to enable a terminal device (which may be a mobile phone, a computer, a server, a network device, or the like) to perform the methods described in all the embodiments of present disclosure.

This embodiment further provides a voltage regulation apparatus. The apparatus is configured to implement the above embodiments and optional implementations. Those contents that have been described will not be elaborated. As used below, the term “module” may be a combination of software and/or hardware that implements a predetermined function. Although the apparatus described in the following embodiments is preferably implemented in software, the implementation of hardware or a combination of software and hardware is also possible and envisioned.

FIG. 8 is a structural block diagram of a voltage regulation apparatus according to an embodiment of the present disclosure. As shown in FIG. 8, the apparatus includes:

a generation module 82, configured to: generate a first switching signal according to a previous-stage input voltage of a voltage regulation circuit and a second switching signal of a rectification circuit in the voltage regulation circuit, wherein the voltage regulation circuit includes: an input-output branch and a regulation branch; the regulation branch includes: the rectification circuit and a voltage regulator; the input-output branch outputs a direct-current voltage by controlling a switching frequency, and the regulation branch controls the direct-current voltage to be constant by adjusting a target input voltage of the input-output branch; the rectification circuit is connected to the voltage regulator; an output voltage of the voltage regulator is a regulated voltage; the regulated voltage and the previous-stage input voltage are used as the target input voltage; the second switching signal is used for rectifying an input voltage of the regulation branch; and

an output module 84, configured to output the first switching signal to the rectification circuit, wherein the first switching signal is used for controlling the regulated voltage.

Through the above apparatus, the voltage regulation circuit includes: an input-output branch and a regulation branch. The input-output branch outputs a direct-current voltage by controlling a switching frequency. The regulation branch controls the direct-current voltage to be constant by adjusting a target input voltage of the input-output branch. The regulation branch includes: a signal processor, a rectification circuit, and a voltage regulator. The rectification circuit is connected to the voltage regulator. An output voltage of the voltage regulator is a regulated voltage output by the regulation branch. The regulated voltage and the previous-stage input voltage of the voltage regulation circuit are used as the target input voltage. The signal processor is connected to the rectification circuit. The signal processor is configured to output a first switching signal to the rectification circuit to control the regulated voltage. Namely, the voltage regulation is controlled by the first switching signal provided to the rectification circuit, instead of controlling the voltage regulator, so that an additional switch transistor, inductor, capacitor, diode, and the like do not need to be added into the voltage regulation circuit. Due to the deployment of eliminating a plurality of components in the voltage regulation circuit, a space occupied by the device is saved. Therefore, the problem of high complexity of the voltage regulation circuit is solved, and thus, an effect of reducing the complexity of the voltage regulation circuit is achieved.

In an exemplary embodiment, the generation module is configured to: generate a control signal according to the previous-stage input voltage and a desired output voltage of the input-output branch, wherein the control signal is used for controlling the direct-current voltage to be constant; and use the control signal to convert the second switching signal of the rectification circuit into the first switching signal.

In an exemplary embodiment, the generation module is configured to: calculate a branch output voltage that is matched with the previous-stage input voltage and the desired output voltage; determine a duty cycle that is matched with the branch output voltage; and generate the control signal that conforms to the duty cycle.

In an exemplary embodiment, the generation module is configured to perform an AND logical operation on the control signal and the second switching signal to obtain the first switching signal.

It should be noted that the above modules may be implemented through software or hardware. For the latter, the various modules may be implemented in the following ways, but not limited to: The above modules are all located in the same processor; or, the aforementioned modules may be located in different processors in the form of any combination.

The embodiments of the present disclosure further provide a non-volatile readable storage medium, having a computer program stored thereon. The computer program is configured to, when run, execute the operations in any one of the above method embodiments.

In an exemplary embodiment, the above non-volatile readable storage medium may include but not limited to: various media that may store computer programs, such as a USB flash drive, a ROM, a RAM, a mobile hard disk drive, a magnetic disk, and a compact disc.

The embodiments of the present disclosure further provide an electronic device, including a memory and a processor. The memory has a computer program stored thereon. The processor is configured for running the computer program to execute the operations in any one of the above method embodiments.

In an exemplary embodiment, the aforementioned electronic device may further include a transmission device and an input-output device, wherein the transmission device is connected to the above processor, and the input-output device is connected to the above processor.

The optional examples in this embodiment may be found in the examples described in the above embodiments and exemplary implementations, and will not be elaborated in this embodiment.

Obviously, those skilled in the art should understand that the various modules or operations of the present disclosure may be implemented using a universal computing apparatus, which may be concentrated on a single computing apparatus or distributed on a network composed of a plurality of computing apparatuses. The modules or operations may be implemented using program codes that may be executed by a computing apparatus, so that the modules or operations may be stored in a storage apparatus for execution by the computing apparatus. Furthermore, in some cases, the operations shown or described may be executed in an order different from those here, or the operations may be separately made into various integrated circuit modules, or a plurality of modules or operations among the modules or operations may be made into single integrated circuit modules for implementation. In this way, the present disclosure is not limited to any specific combinations of hardware and software.

The above descriptions are only optional embodiments of the present disclosure, and are not intended to limit the present disclosure. For those skilled in the art, the present disclosure may have various modifications and changes. Any modification, equivalent replacement, and improvement made within the principles of the present disclosure shall fall within the protection scope of the present disclosure.

1. A voltage regulation circuit, comprising an input-output branch and a regulation branch, wherein the regulation branch comprises: a signal processor, a rectification circuit, and a voltage regulator, wherein
the input-output branch outputs a direct-current voltage by controlling a switching frequency, and the regulation branch controls the direct-current voltage to be constant by adjusting a target input voltage of the input-output branch;
the rectification circuit is connected to the voltage regulator, an output voltage of the voltage regulator is a regulated voltage output by the regulation branch, and the regulated voltage and a previous-stage input voltage of the voltage regulation circuit are used as the target input voltage; and
the signal processor is connected to the rectification circuit, and the signal processor is configured to output a first switching signal to the rectification circuit to control the regulated voltage.

2. The voltage regulation circuit according to claim 1, wherein the voltage regulator comprises an energy storage inductor and an output filtering capacitor, wherein
a high-level output end of the rectification circuit is connected to one end of the energy storage inductor, the other end of the energy storage inductor is connected to one end of the output filtering capacitor, the other end of the output filtering capacitor is connected to a low-level output end of the rectification circuit, and a voltage across two ends of the output filtering capacitor is the output voltage of the voltage regulator.

3. The voltage regulation circuit according to claim 2, wherein the rectification circuit is a controllable rectification circuit, and the controllable rectification circuit comprises one or more controllable elements, wherein
when the controllable rectification circuit comprises a plurality of controllable elements, the signal processor is configured to output the first switching signal to all or part of the plurality of controllable elements.

4. The voltage regulation circuit according to claim 3, wherein the one or more controllable elements form a bridge rectification circuit, wherein
one output end of the bridge rectification circuit as the high-level output end of the rectification circuit and is connected to the energy storage inductor, and the other output end of the bridge rectification circuit as the low-level output end of the rectification circuit and is connected to the output filtering capacitor.

5. The voltage regulation circuit according to claim 4, wherein the one or more controllable elements comprise a first controllable switch transistor, a second controllable switch transistor, a third controllable switch transistor, and a fourth controllable switch transistor, which together form a full-bridge rectification circuit; and the signal processor is respectively connected to a control end of the first controllable switch transistor, a control end of the second controllable switch transistor, a control end of the third controllable switch transistor, and a control end of the fourth controllable switch transistor.

6. The voltage regulation circuit according to claim 1, wherein the signal processor is connected between an output end of the input-output branch and the rectification circuit; and
the signal processor is configured to generate a control signal according to the previous-stage input voltage and a desired output voltage of the input-output branch, wherein the control signal is used for controlling the direct-current voltage to be constant, the signal processor is configured to convert a second switching signal of the rectification circuit into the first switching signal by using the control signal, wherein the second switching signal is used for rectifying an input voltage of the regulation branch.

7. The voltage regulation circuit according to claim 6, wherein the signal processor is configured to calculate a branch output voltage that is matched with the previous-stage input voltage and the desired output voltage; the signal processor is configured to determine a duty cycle that is matched with the branch output voltage; the signal processor is configured to generate the control signal that conforms to the duty cycle; and the signal processor is configured to perform an AND logical operation on the control signal and the second switching signal to obtain the first switching signal.

8. The voltage regulation circuit according to claim 1, wherein the input-output branch is a logical link control (LLC) circuit topology, and the regulation branch is a BUCK circuit topology;
the LLC circuit topology comprises a primary-side primary winding circuit and a secondary-side secondary winding circuit, the LLC circuit topology operates in a direct-current mode of MHz and transfers electric energy from the primary-side primary winding circuit to the secondary-side secondary winding circuit to output the direct-current voltage;
the BUCK circuit topology comprises an energy storage inductor and an output filtering capacitor, and the rectification circuit is connected between a primary-side auxiliary winding and the BUCK circuit topology.

9. The voltage regulation circuit according to claim 8, wherein the signal processor is configured to perform an AND logical operation on a switching signal of the rectification circuit and a switching signal of the BUCK circuit topology to obtain the first switching signal and input the first switching signal to the rectification circuit;
wherein the switching signal of the rectification circuit is used for controlling a rectification function of the rectification circuit, and the switching signal of the BUCK circuit topology is used for controlling a step-down function of the BUCK circuit topology.

10. A server power supply, comprising: a power supply circuit and a voltage regulation circuit, wherein the voltage regulation circuit is connected between the power supply circuit and a server load to be powered;
the voltage regulation circuit comprises an input-output branch and a regulation branch, wherein the regulation branch comprises a signal processor, a rectification circuit, and a voltage regulator; the input-output branch outputs a direct-current voltage to the server load by controlling a switching frequency, the regulation branch controls the direct-current voltage to be constant by adjusting a target input voltage of the input-output branch;
the rectification circuit is connected to the voltage regulator, an output voltage of the voltage regulator is a regulated voltage output by the regulation branch, the regulated voltage and an output voltage of the power supply circuit are used as the target input voltage;
the signal processor is connected to the rectification circuit, and the signal processor is configured to output a first switching signal to the rectification circuit to control the regulated voltage.

11. The server power supply according to claim 10, wherein the voltage regulator comprises an energy storage inductor and an output filtering capacitor, the rectification circuit is a controllable rectification circuit, one or more controllable elements comprised in the controllable rectification circuit form a bridge rectification circuit;
a high-level output end of the bridge rectification circuit is connected to one end of the energy storage inductor, the other end of the energy storage inductor is connected to one end of the output filtering capacitor, the other end of the output filtering capacitor is connected to a low-level output end of the bridge rectification circuit, a voltage across two ends of the output filtering capacitor is the output voltage of the voltage regulator; the one or more controllable elements comprise a first controllable switch transistor, a second controllable switch transistor, a third controllable switch transistor, and a fourth controllable switch transistor, which together form a full-bridge rectification circuit; and the signal processor is respectively connected to control ends of the one or more controllable elements.

12. The server power supply according to claim 10, wherein
the signal processor is connected between an output end of the voltage regulation circuit and the rectification circuit;
the signal processor is configured to generate a control signal according to an output voltage of the power supply circuit and an operating voltage of the server load, wherein the control signal is used for controlling the direct-current voltage to be constant; the signal processor is configured to convert a second switching signal of the rectification circuit into the first switching signal by using the control signal, and the signal processor is configured to input the first switching signal to the rectification circuit, wherein the second switching signal is used for rectifying an input voltage of the regulation branch.

13. The server power supply according to claim 12, wherein the signal processor is configured to calculate a branch output voltage that is matched with the output voltage of the power supply circuit and the operating voltage of the server load; the signal processor is configured to determine a duty cycle that is matched with the branch output voltage; the signal processor is configured to generate the control signal that conforms to the duty cycle; and the signal processor is configured to perform an AND logical operation on the control signal and the second switching signal to obtain the first switching signal.

14. The server power supply according to claim 10, wherein the input-output branch is a logical link control (LLC) circuit topology, and the regulation branch is a BUCK circuit topology;
the LLC circuit topology comprises a primary-side primary winding circuit and a secondary-side secondary winding circuit, the LLC circuit topology operates in a direct-current mode of MHz to transfer electric energy from the primary-side primary winding circuit to the secondary-side secondary winding circuit, to output a constant direct-current voltage to the server load;
the BUCK circuit topology comprises an energy storage inductor and an output filtering capacitor, and the rectification circuit is connected between a primary-side auxiliary winding and the BUCK circuit topology.

15. The server power supply according to claim 14, wherein the signal processor is configured to perform an AND logical operation on a switching signal of the rectification circuit and a switching signal of the BUCK circuit topology to obtain the first switching signal and input the first switching signal to the rectification circuit;
wherein the switching signal of the rectification circuit is used for controlling a rectification function of the rectification circuit, and the switching signal of the BUCK circuit topology is used for controlling a step-down function of the BUCK circuit topology.

16. A voltage regulation method, comprising:
generating a first switching signal according to a previous-stage input voltage of a voltage regulation circuit and a second switching signal of a rectification circuit in the voltage regulation circuit, wherein the voltage regulation circuit comprises: an input-output branch and a regulation branch, the regulation branch comprises: the rectification circuit and a voltage regulator, wherein the input-output branch outputs a direct-current voltage by controlling a switching frequency, and the regulation branch controls the direct-current voltage to be constant by adjusting a target input voltage of the input-output branch, the rectification circuit is connected to the voltage regulator, an output voltage of the voltage regulator is a regulated voltage, the regulated voltage and the previous-stage input voltage are used as the target input voltage, the second switching signal is used for rectifying an input voltage of the regulation branch; and
outputting the first switching signal to the rectification circuit, wherein the first switching signal is used for controlling the regulated voltage.

17. The method according to claim 16, wherein generating the first switching signal according to the previous-stage input voltage of the voltage regulation circuit and the second switching signal of the rectification circuit in the voltage regulation circuit comprises:
generating a control signal according to the previous-stage input voltage and a desired output voltage of the input-output branch, wherein the control signal is used for controlling the direct-current voltage to be constant; and
using the control signal to convert the second switching signal of the rectification circuit into the first switching signal.

18. The method according to claim 17, wherein generating the control signal according to the previous-stage input voltage and the desired output voltage of the input-output branch comprises:
calculating a branch output voltage that is matched with the previous-stage input voltage and the desired output voltage;
determining a duty cycle that is matched with the branch output voltage; and
generating the control signal that conforms to the duty cycle.

19. The method according to claim 17, wherein using the control signal to convert the second switching signal of the rectification circuit into the first switching signal comprises:
performing an AND logical operation on the control signal and the second switching signal to obtain the first switching signal.

20. (canceled)

21. A non-volatile readable storage medium, storing a computer program, wherein the computer program, when executed by a processor, implements the operations of the method according to claim 16.

22. (canceled)
